(19) United States
(12) Patent Application Publication
(10) Pub. No.: US 2024/0231569 A1
(43) Pub. Date: Jul. 11, 2024

(54) Content Stacks

(71) Applicant: Apple Inc., Cupertino, CA (US)

(72) Inventors: Shih-Sang Chiu, Menlo Park, CA (US); Benjamin H. Boesel, Sunnyvale, CA (US); David H. Huang, San Mateo, CA (US); Jonathan Perron, Felton, CA (US); Jonathan Ravasz, Sunnyvale, CA (US); Jordan A. Cazamias, San Francisco, CA (US); Tyson Erze, Felton, CA (US)

(21) Appl. No.: 18/563,057

(22) PCT Filed: May 31, 2022
(86) PCT No.: PCT/US2022/031564

§ 371 Date: Nov. 21, 2023

Related U.S. Application Data
(60) Provisional application No. 63/210,415, filed on Jun. 14, 2021.

(51) Int. Cl. G06F 3/0483; G06F 3/01; G06F 3/04815; G06F 3/04842

(52) U.S. Cl. CPC G06F 3/0483; G06F 3/013; G06F 3/017; G06F 3/04815; G06F 3/04842; G06F 2203/04803

(57) ABSTRACT

In one implementation, a method of displaying content is performed at a device including a display, one or more processors, and non-transitory memory. The method includes displaying, in a first area, a first content pane including first content including a link to second content. The method includes, while displaying the first content pane in the first area, receiving a user input selecting the link to the second content and indicating a second area separate from the first area and not displaying a content pane. The method includes, in response to receiving the user input selecting the link to the second content and indicating the second area, displaying, in the second area, a second content pane including the second content.

### CROSS-REFERENCE TO RELATED APPLICATIONS

This application is the national phase entry of Intl. Patent App. No. PCT/US2022/031564, filed on May 31, 2022, which claims priority to U.S. Provisional Patent No. 63/210,415, filed on Jun. 14, 2021, which are both hereby incorporated by reference in their entirety.

### TECHNICAL FIELD

The present disclosure generally relates to systems, methods, and devices for presenting content.

### BACKGROUND

In a desktop environment, a web browser allows a user to browse content including links to other content and to generate windows or tabs displaying the other content. In various implementations, this leads to a proliferation of windows or tabs in the desktop environment that makes it difficult to find particular content the user is interested in consuming.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIGS. 4A-4S illustrate an XR environment during various time periods in accordance with some implementations.

FIG. 5 is a flowchart representation of a method of displaying content in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying content. In various implementations, the method is performed by a device including a display, one or more processors, and non-transitory memory. The method includes displaying, in a first area, a first content pane including first content including a link to second content. The method includes, while displaying the first content pane in the first area, receiving a user input selecting the link to the second content and indicating a second area separate from the first area and not displaying a content pane. The method includes, in response to receiving the user input selecting the link to the second content and indicating the second area, displaying, in the second area, a second content pane including the second content.

### DESCRIPTION

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As noted above, in a desktop environment, a web browser allows a user to browse content including links to other content and to generate windows or tabs displaying the other content. In various implementations, this leads to a proliferation of windows or tabs in the desktop environment that makes it difficult to find particular content the user is interested in consuming. In contrast, an XR environment provides opportunities to generate and manipulate content panes displaying content in such a way that content is easily accessible.

For example, in various implementations, dragging a link from a content pane in an XR environment to a blank area in the XR environment (e.g., an area not displaying a content pane) generates a new content pane. In contrast, dragging a link from a window of a web browser in a desktop environment to a blank area in the desktop environment (e.g., an area not displaying a window, such as the desktop) generates a shortcut to the web browser.

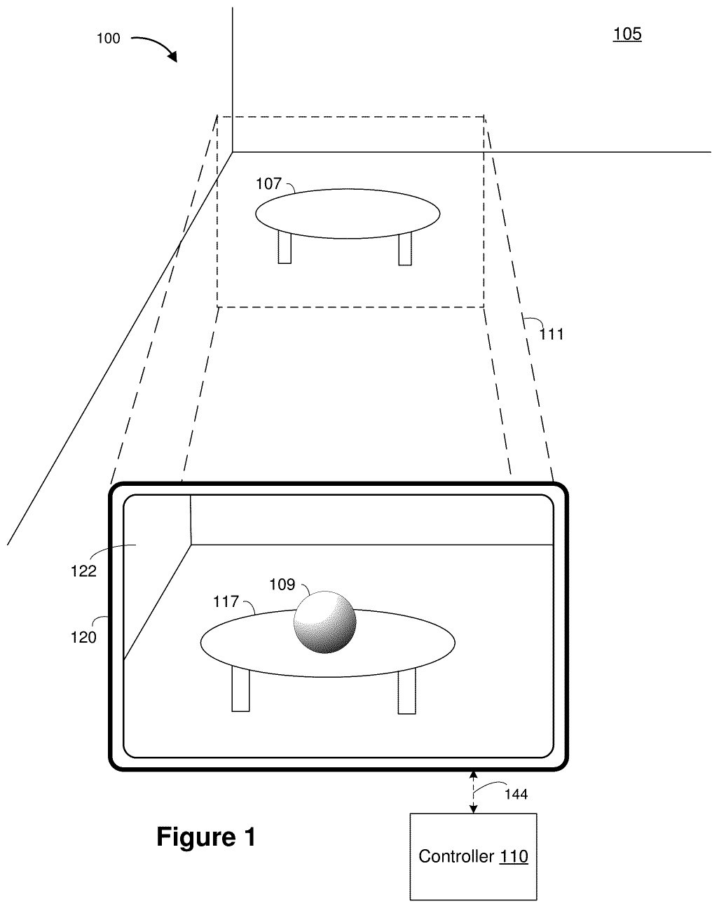

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

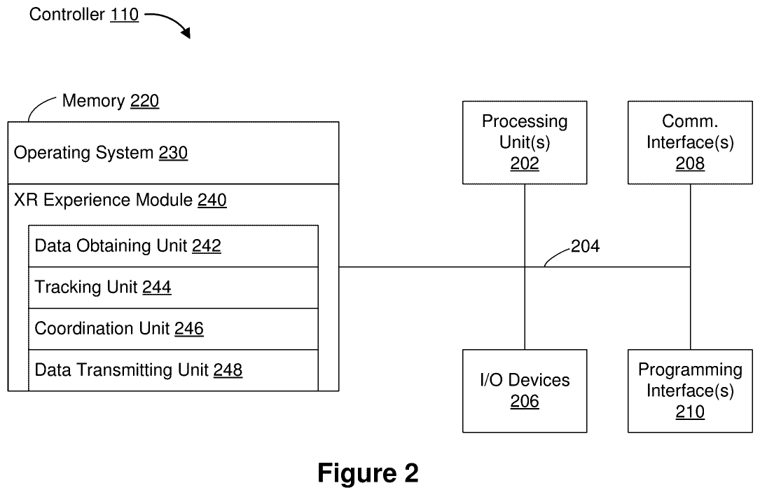

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

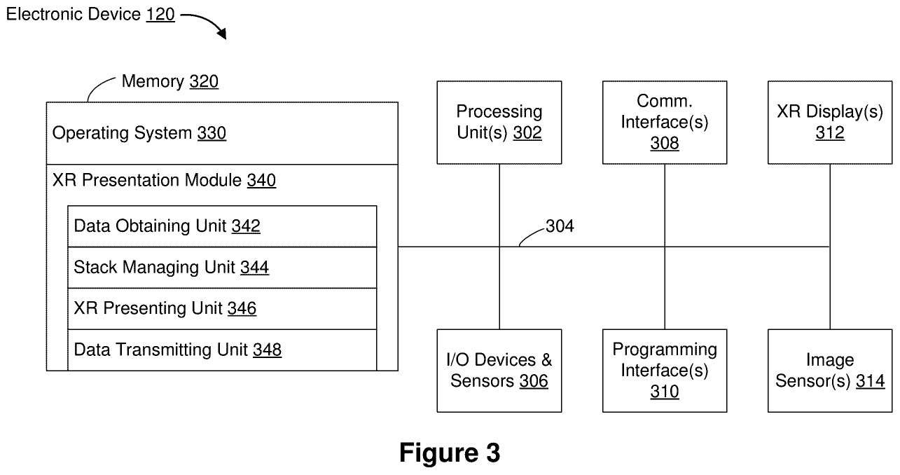

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR sphere 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, a stack managing unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, a stack managing unit 344 is configured to display content in an XR environment in one or more stacks of content panes. To that end, in various implementations, the stack managing unit 344 includes instructions and/or logic therefor, and heuristics and metadata therefor.

In some implementations, the XR presenting unit 346 is configured to present XR content via the one or more XR displays 312, such as a representation of the selected text input field at a location proximate to the text input device. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. In some implementations, the data transmitting unit 348 is configured to transmit authentication credentials to the electronic device. To that end, in various implementations, the data transmitting unit 348 includes instructions and/or logic therefor, and heuristics and metadata therefor.

Although the data obtaining unit 342, the stack managing unit 344, the XR presenting unit 346, and the data transmitting unit 348 are shown as residing on a single device (e.g., the electronic device 120), it should be understood that in other implementations, any combination of the data obtaining unit 342, the stack managing unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

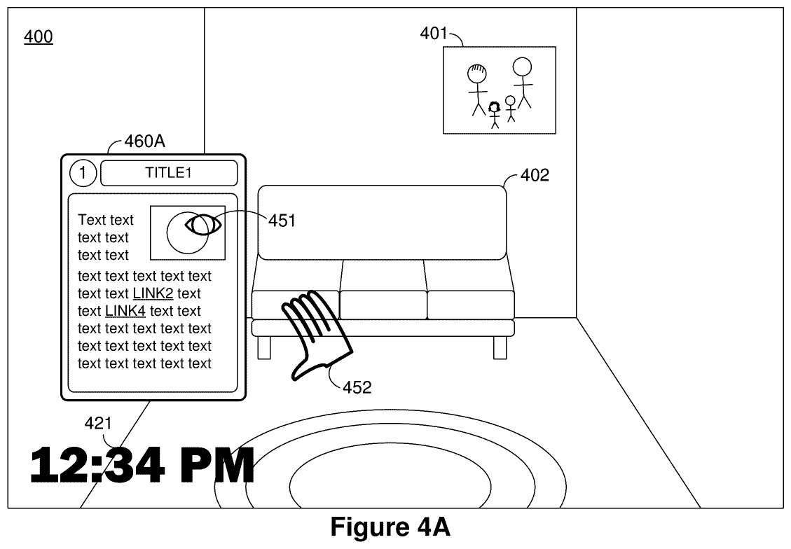

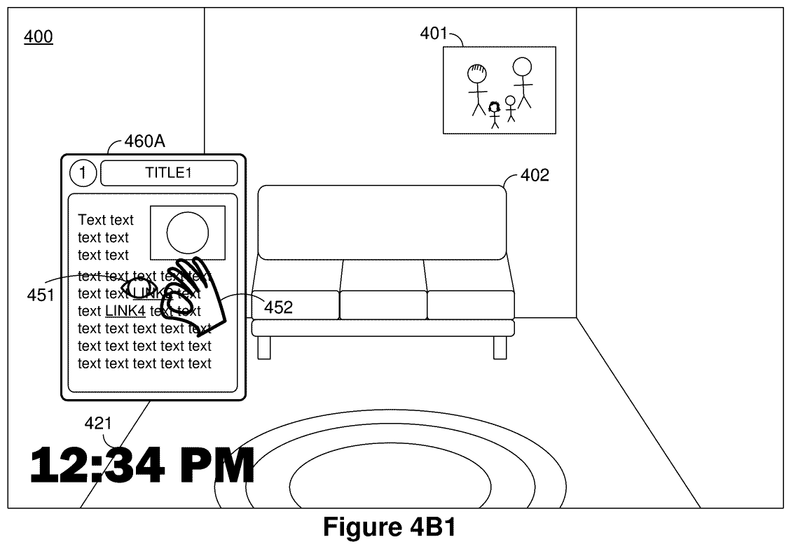

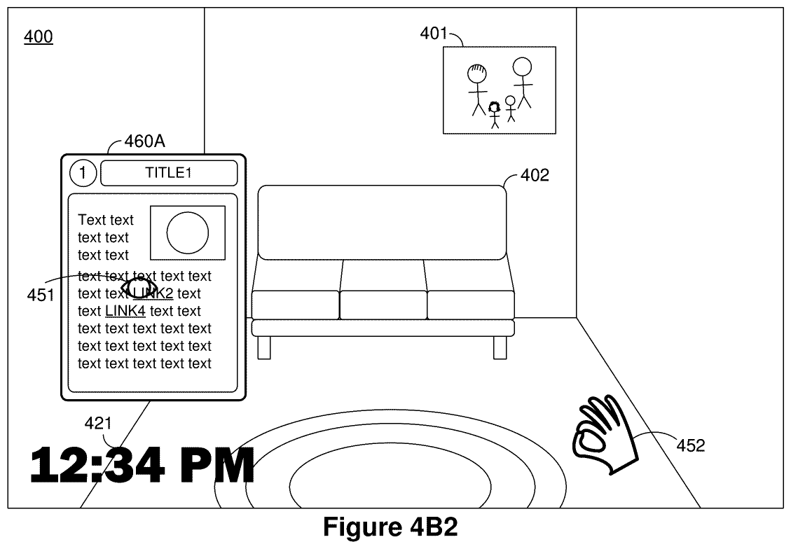

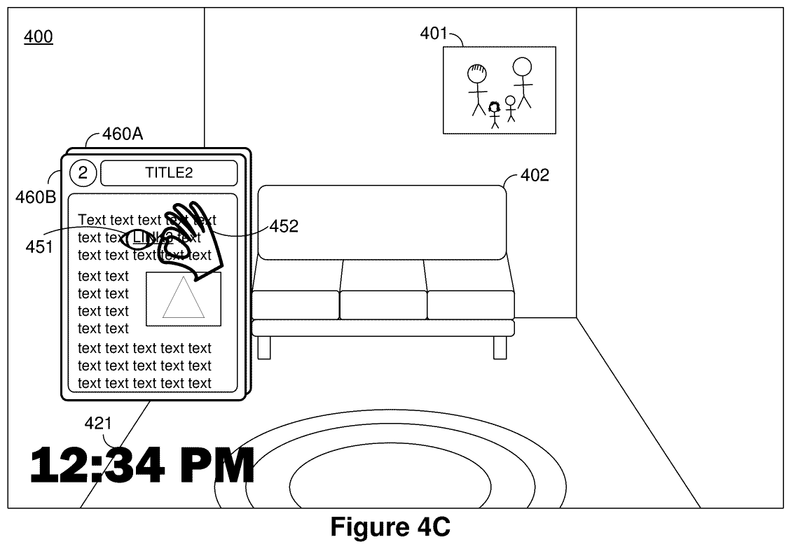

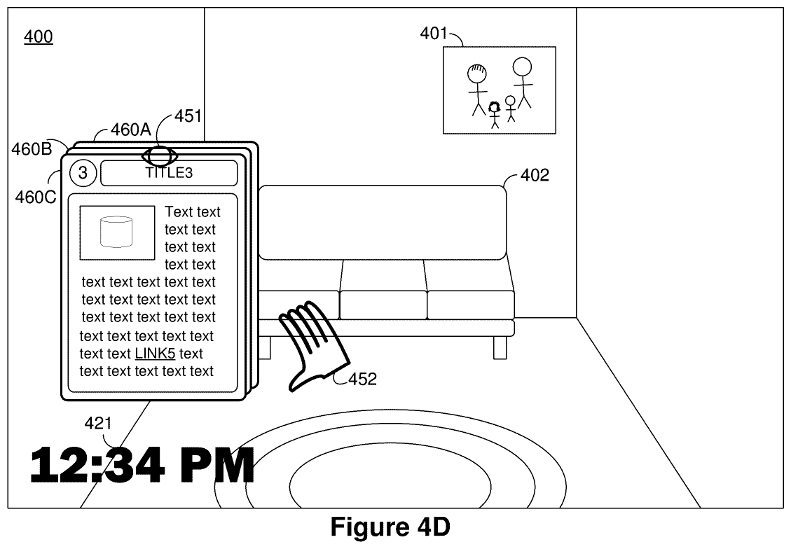

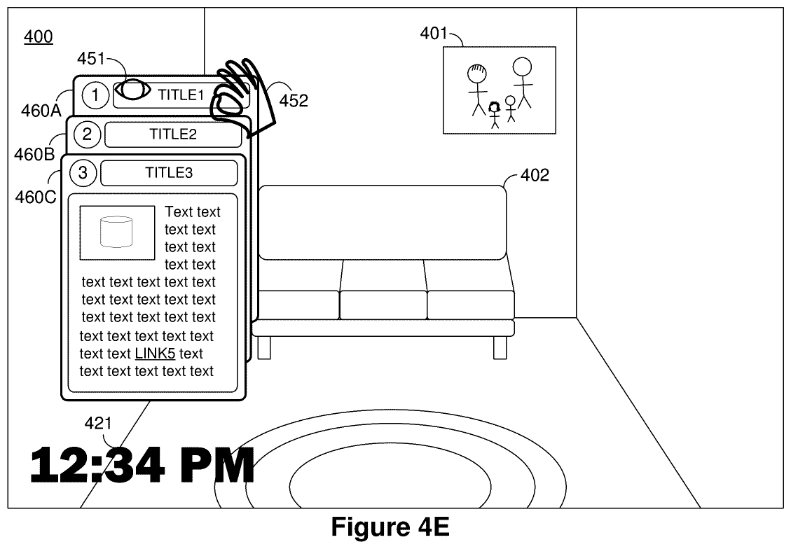

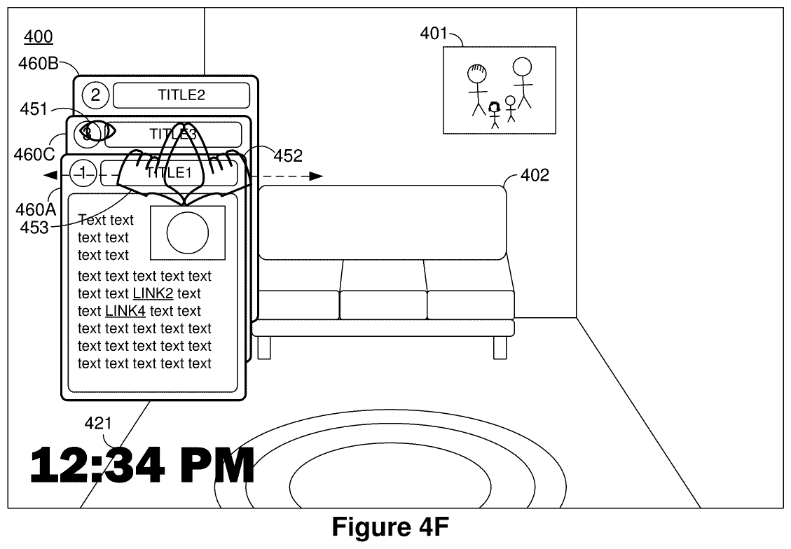

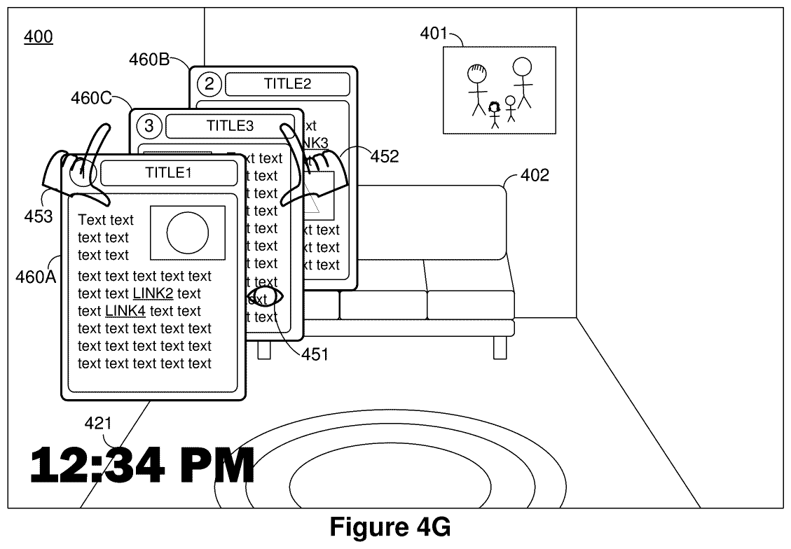

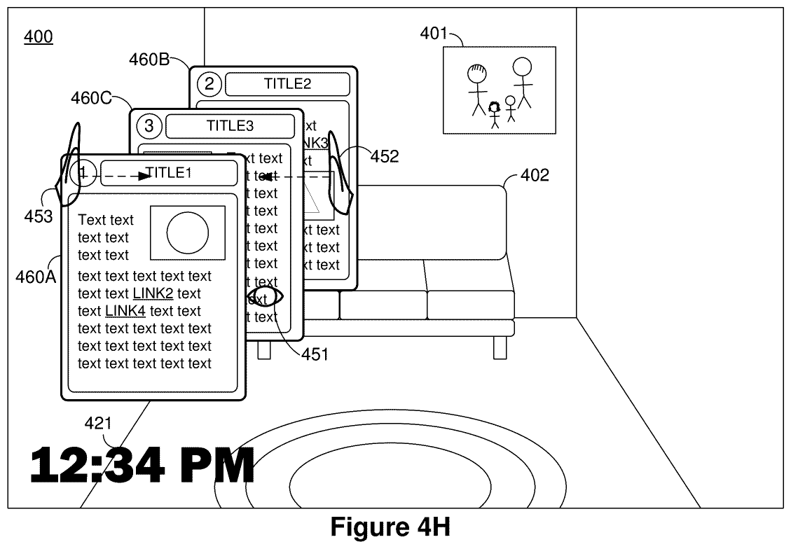

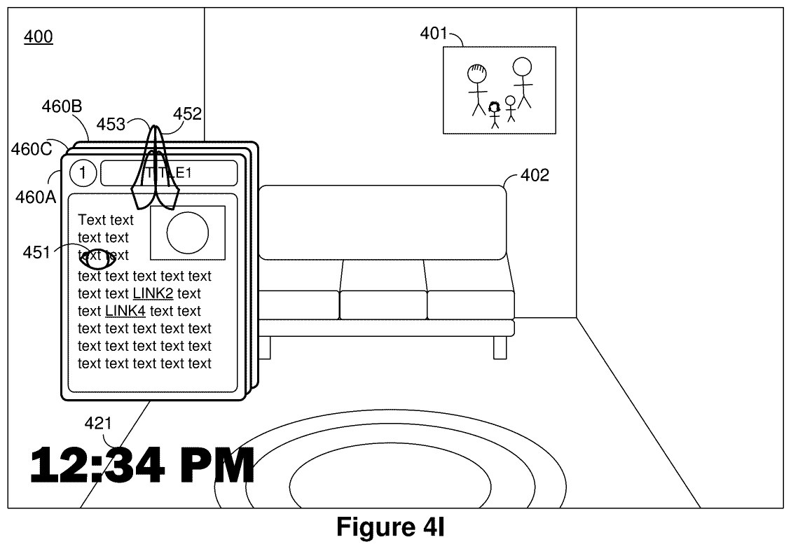

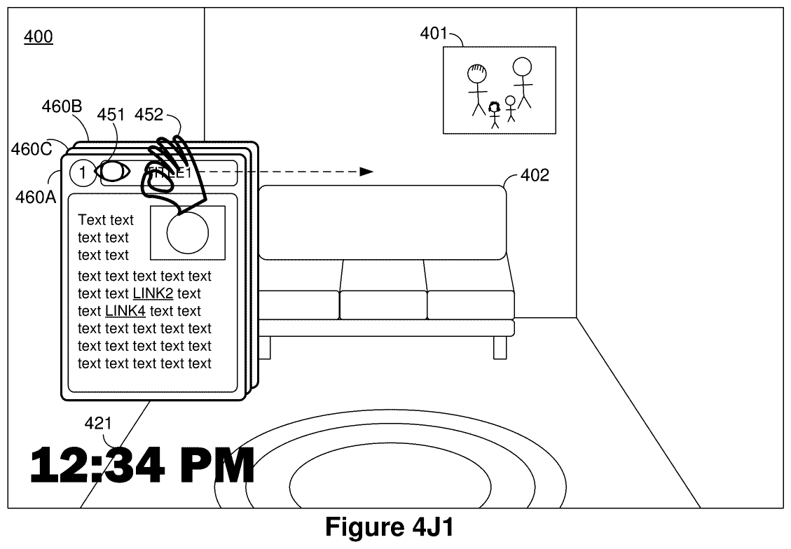

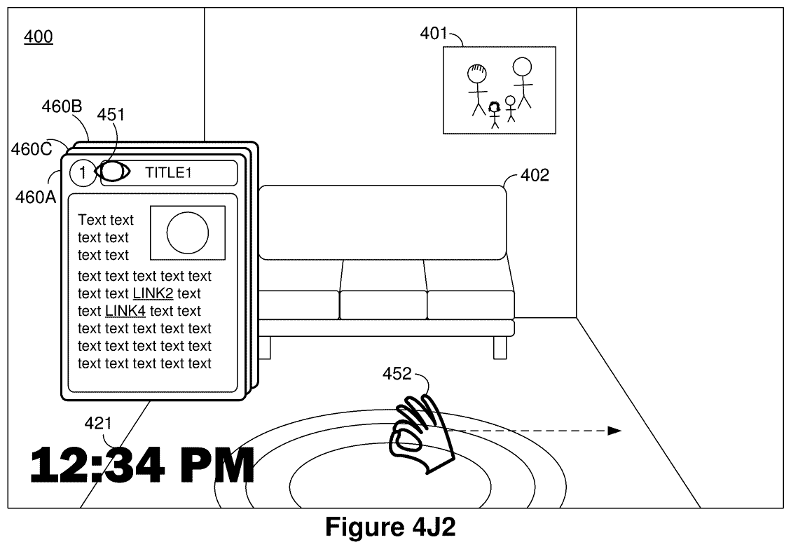

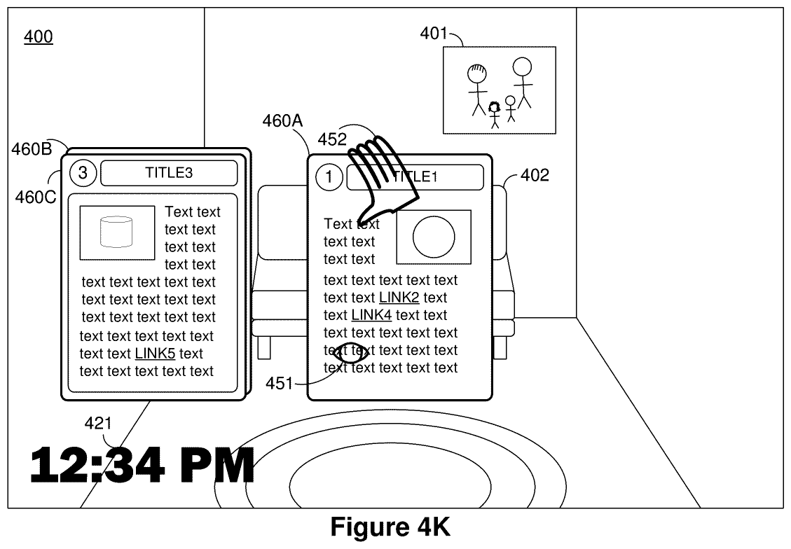

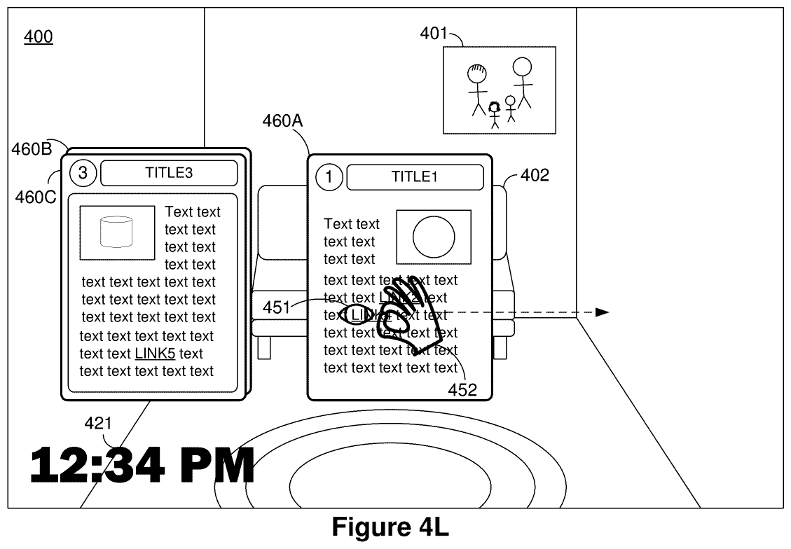

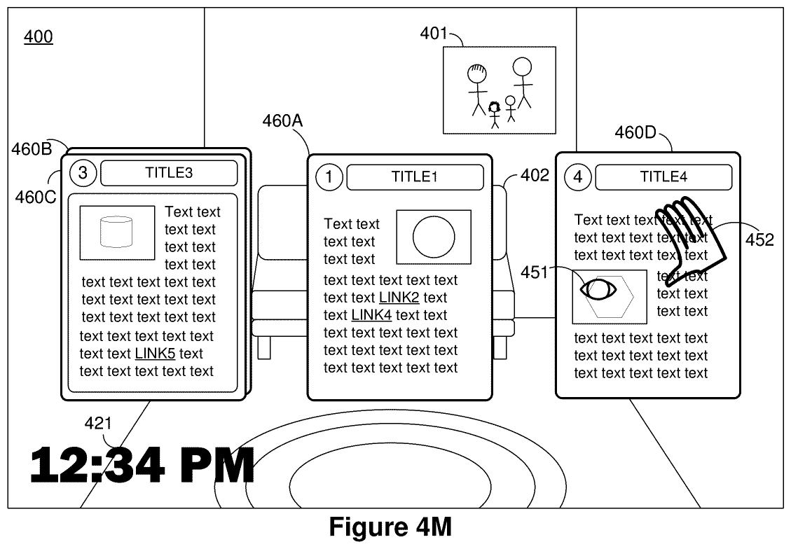

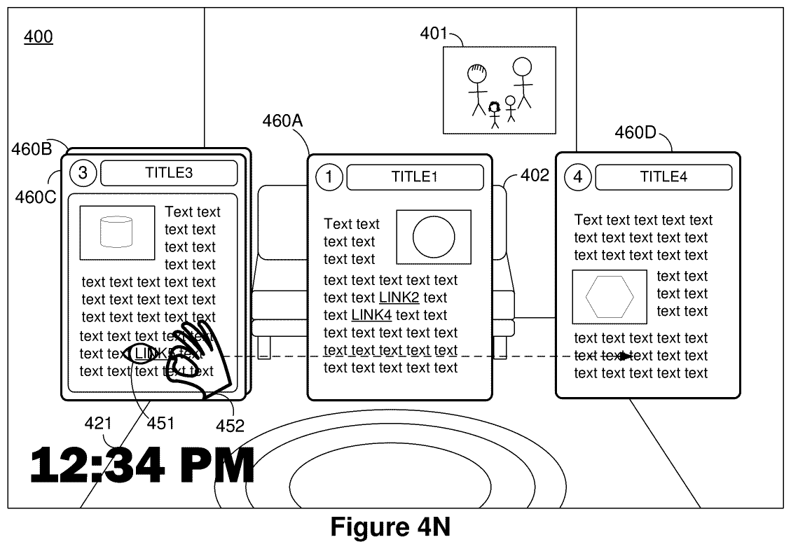

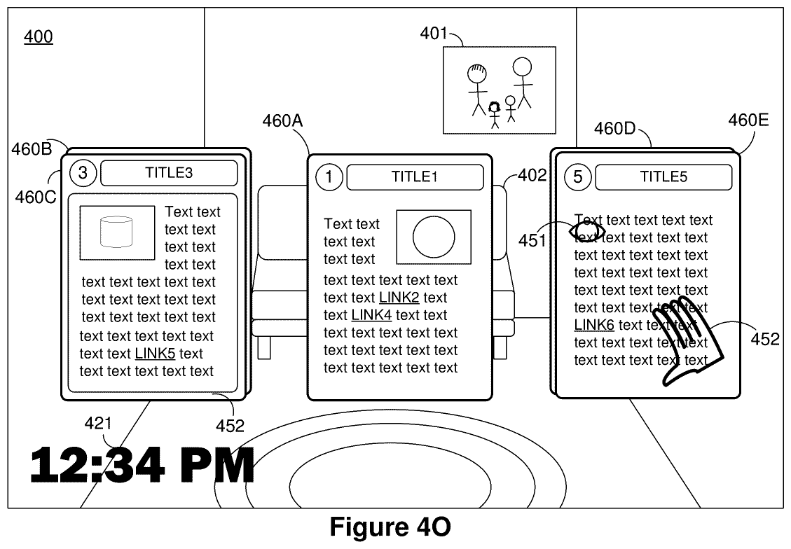

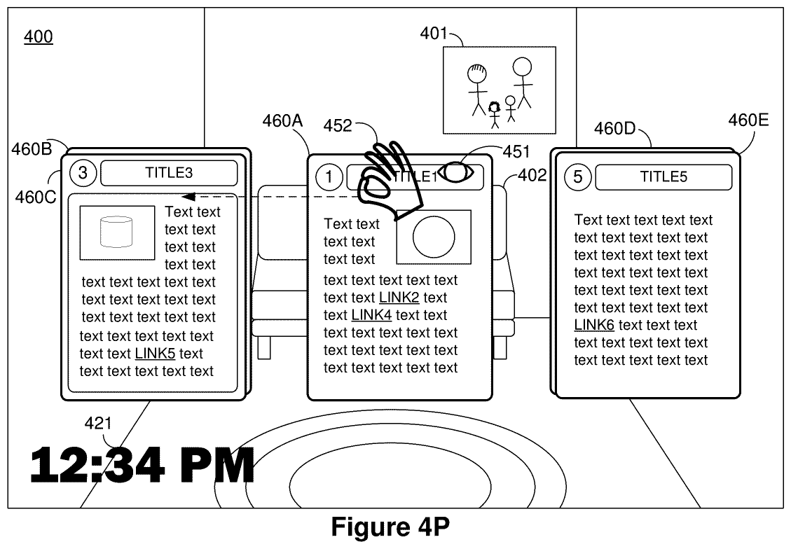

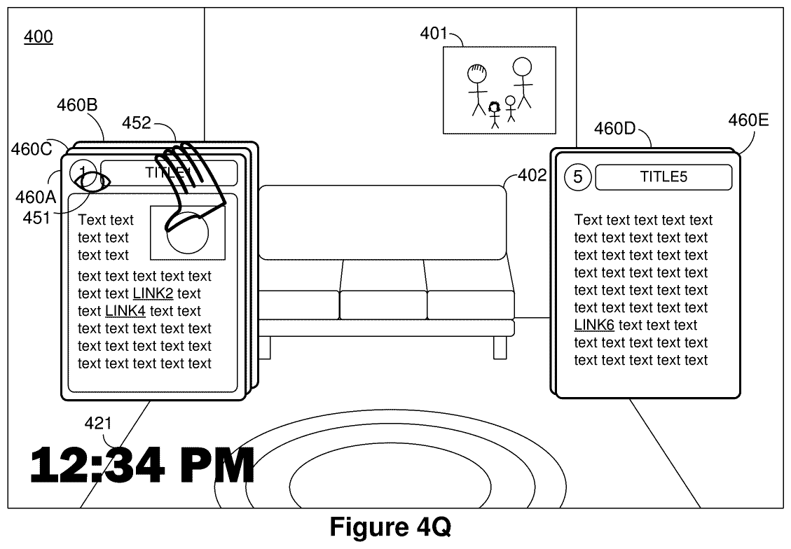

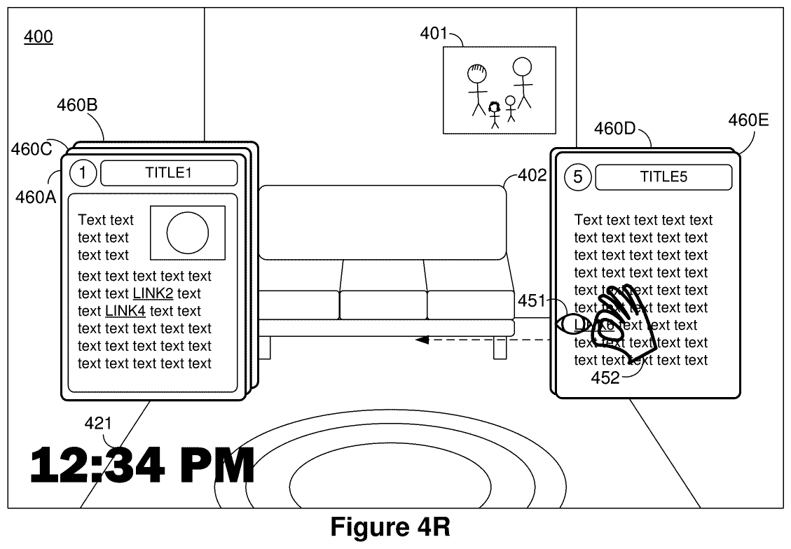

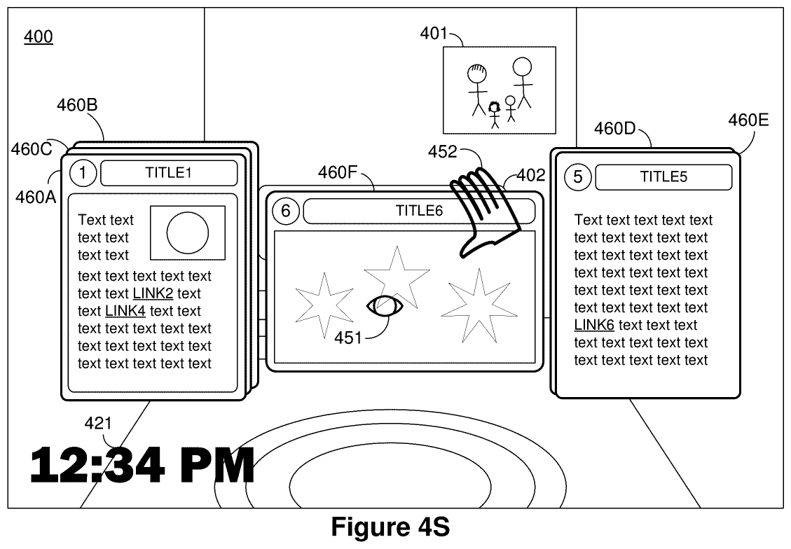

FIGS. 4A-4S illustrate an XR environment 400 displayed, at least in part, by a display of the electronic device. The XR environment 400 is based on a physical environment of a living room in which the electronic device is present. FIGS. 4A-4S illustrate the XR environment 400 during a series of time periods. In various implementations, each time period is an instant, a fraction of a second, a few seconds, a few hours, a few days, or any length of time.

The XR environment 400 includes a plurality of objects, including one or more physical objects (e.g., a picture 401 and a couch 402) of the physical environment and one or more virtual objects (e.g., a first content pane 460A and a virtual clock 421). In various implementations, certain objects (such as the physical objects 401 and 402 and the first content pane 460A) are displayed at a location in the XR environment 400, e.g., at a location defined by three coordinates in a three-dimensional (3D) XR coordinate system. Accordingly, when the electronic device moves in the XR environment 400 (e.g., changes either position and/or orientation), the objects are moved on the display of the electronic device, but retain their location in the XR environment 400. Such virtual objects that, in response to motion of the electronic device, move on the display, but retain their position in the XR environment are referred to as world-locked objects. In various implementations, certain virtual objects (such as the virtual clock 421) are displayed at locations on the display such that when the electronic device moves in the XR environment 400, the objects are stationary on the display on the electronic device. Such virtual objects that, in response to motion of the electronic device, retain their location on the display are referred to as head-locked objects or display-locked objects.

FIGS. 4A-4S illustrate a gaze direction indicator 451 that indicates a gaze direction of the user, e.g., where in the XR environment 400 the user is looking. Although the gaze direction indicator 451 is illustrated in FIGS. 4A-4S, in various implementations, the gaze direction indicator 451 is not displayed by the electronic device.

FIGS. 4A-4S illustrate a right hand 452 and a left hand 453 of a user. To better illustrate interaction of the right hand 452 and the left hand 453 with virtual objects, the right hand 452 and the left hand 453 are illustrated as transparent.

FIG. 4A illustrates the XR environment 400 during a first time period. During the first time period, the electronic device displays the first content pane 460A at a first location in the XR environment 400. The first content pane 460A includes, at the top of the first content pane 460A, a first icon and a first title (labeled “TITLE1”). The first content pane 460A further includes first content including a first image and first text. The first text includes a link to second content (labeled “LINK2”) and a link to fourth content (labeled “LINK4”). In various implementations, the first content is a first webpage, the link to the second content is a link to a second webpage, and the link to the fourth content is a link to a fourth webpage. Thus, in various implementations, the first content pane 460A is a content pane of a web browser.

The first content pane 460A spans a two-dimensional plane in a horizontal direction (e.g., an x-direction) and a vertical direction (e.g., y-direction). The first content pane 460A further defines a depth direction (e.g., a z-direction) perpendicular to first content pane 460A.

During the first time period, the gaze direction indicator 451 indicates that the user is looking at the first image. During the first time period, the right hand 452 is in a neutral position.

FIG. 4B1 illustrates the XR environment 400 during a second time period subsequent to the first time period. During the second time period, the gaze direction indicator 451 indicates that the user is looking at the link to the second content. During the second time period, the right hand 452 performs a pinch gesture at the location of the link to the second content (as illustrated in FIG. 4B1) and a release gesture at a location of the first content pane 460A.

In various implementations, a user performs a pinch gesture by contacting a fingertip of the index finger to the fingertip of the thumb. In various implementations, a user performs a release gesture by ceasing contact of the index finger and the thumb. However, in various implementations, other gestures may correspond to a pinch gesture or release gesture.

FIG. 4B2 illustrates an alternative embodiment of the XR environment 400 during the second time period. Whereas FIG. 4B1 illustrates the right hand 452 performing a pinch gesture at the location of the link to the second content, FIG. 4B2 illustrates the right hand 452 performing a pinch gesture at a location at least a threshold distance from the link to the second content. In particular, the pinch gesture is at a location at least a threshold distance from any user interface element. Further, the pinch gesture is at a location at least a threshold distance from the location at which the user is looking as indicated by the gaze direction indicator 451. Thus, during the second time period, the right hand 452 performs at pinch gesture at a location at least a threshold distance from the link to the second content (as illustrated in FIG. 4B2) and a release gesture at approximately the same location.

FIG. 4C illustrates the XR environment 400 during a third time period subsequent to the second time period. During the third time period, in response to detecting the pinch gesture interacting with the link to the second content and the release gesture associated with the location of the first content pane 460A, the XR environment 400 includes a second content pane 460B at the first location and the first content pane 460A at a second location displaced backward (e.g., away from the electronic device) in the depth direction. In various implementations, the first content pane 460A remains at the first location and the second content pane 460B is positioned at a second location in front of first content page 460A (e.g., toward the electronic device).

In various implementations, detecting the pinch gesture interacting with the link to the second content includes detecting a pinch gesture at the location of the link to the second content (e.g., as illustrated in FIG. 4B1). In various implementations, detecting the pinch gesture interacting with the link to the second content includes detecting a pinch gesture at least a threshold distance from the link to the second content while the user is looking at the link to the second content (e.g., as illustrated in FIG. 4B2). In various implementations, detecting the pinch gesture interacting with the link to the second content includes detecting a pinch gesture at least a threshold distance from any user interface element while the user is looking at the link to the second content.

In various implementations, detecting the release gesture associated with the location of the first content pane 460A includes detecting a release gesture at the location of the first content pane 460A. In various implementations, detecting the release gesture associated with the location of the first content pane 460A includes detecting a release gesture while the user is looking at the first content pane 460A. In various implementations, detecting the release gesture associated with the location of the first content pane 460A includes detecting a release gesture at a relative position from the pinch gesture, wherein the relative position causes a corresponding change in location relative to the link to the second content that falls within a location of the first content pane 460A.

The second content pane 460B includes, at the top of the second content pane 460B, a second icon and a second title (labeled “TITLE2”). The second content pane 460B further includes the second content including a second image and second text. The second text includes a link to third content (labeled “LINK3”). In various implementations, the link to the third content is a link to a third webpage.

During the third time period, the second content pane 460B and the first content pane 460A form a first stack in a collapsed configuration. In the collapsed configuration, the content panes of the stack are displaced from each other in the depth direction an amount such that portions of the content panes are visible, but other portions (e.g., the title and content) of only the frontmost content pane is visible. In various implementations, the content panes are aligned (e.g., not offset) in the horizontal direction and the vertical direction. Although, the second content pane 460B and the first content pane 460A are not offset in the horizontal direction or the vertical direction of the XR environment 400, they are offset in the horizontal direction and the vertical direction on the page of FIG. 4C, due to parallax and three-dimensional perspective.

In various implementations, after detecting the pinch gesture interacting with the link to the second content and before detecting the release gesture associated with the location of the first content pane 460A, the electronic device displays a pane representation in the right hand 452, e.g., a virtual object representing the second content pane 460B. In various implementations, the pane representation is partially transparent and the second content pane 460B is opaque. In various implementations, the pane representation is smaller than the second content pane 460B.

In various implementations, in response to detecting a different gesture interacting with the link to the second content (e.g., a touch gesture), the first content pane 460A is changed to display the second content rather than the first content without generating the second content pane 460B.

During the third time period, the gaze direction indicator 451 indicates that the user is looking at the link to the third content. During the third time period, the right hand 452 performs a pinch gesture at the location of the link to the third content (as illustrated in FIG. 4C) and a release gesture at a location of the second content pane 460B.

FIG. 4D illustrates the XR environment 400 during a fourth time period subsequent to the third time period. During the fourth time period, in response to detecting the pinch gesture interacting with the link to the third content and the release gesture associated with a location of the second content pane 460B, the XR environment 400 includes a third content pane 460C at the first location, the second content pane 460B at the second location, and the first content pane 460A at a third location displaced further backward in the depth direction from the second location. In various implementations, the first content pane 460A and the second content pane 460B remain at their respective locations and the third content pane 460C is positioned at a third location in front of the first content page 460A and the second content pane 460B.

In various implementations, detecting the pinch gesture interacting with the link to the third content includes detecting a pinch gesture at the location of the link to the third content (e.g., as illustrated in FIG. 4C). In various implementations, detecting the pinch gesture interacting with the link to the third content includes detecting a pinch gesture at least a threshold distance from the link to the third content while the user is looking at the link to the third content. In various implementations, detecting the pinch gesture interacting with the link to the third content includes detecting a pinch gesture at least a threshold distance from any user interface element while the user is looking at the link to the third content.

In various implementations, detecting the release gesture associated with the location of the second content pane 460B includes detecting a release gesture at the location of the second content pane 460B. In various implementations, detecting the release gesture associated with the location of the second content pane 460B includes detecting a release gesture while the user is looking at the second content pane 460B. In various implementations, detecting the release gesture associated with the location of the second content pane 460B includes detecting a release gesture at a relative position from the pinch gesture, wherein the relative position causes a corresponding change in location relative to the link to the third content that falls within a location of the second content pane 460B.

The third content pane 460C includes, at the top of the third content pane 460C, a third icon and a third title (labeled “TITLE3”). The third content pane 460C further includes the third content including a third image and third text. The third text includes a link to fifth content (labeled “LINK5”). In various implementations, the link to the fifth content is a link to a fifth webpage.

During the fourth time period, the third content pane 460C, the second content pane 460B, and the first content pane 460A form a first stack in a collapsed configuration. In the collapsed configuration, the content panes of the stack are displaced from each other in the depth direction an amount such that portions of the panes are visible, but other portions (e.g., the title and content) of only the frontmost content pane is visible. In various implementations, the content panes are aligned (e.g., not offset) in the horizontal direction and the vertical direction. Although, the third content pane 460C, the second content pane 460B, and the first content pane 460A are not offset in the horizontal direction or the vertical direction of the XR environment 400, they are offset in the horizontal direction and the vertical direction on the page of FIG. 4D, due to parallax and three-dimensional perspective.

During the fourth time period, the gaze direction indicator 451 indicates that the user is looking at the third title, e.g., top of the third content pane 460C. During the fourth time period, the right hand 452 is in a neutral position.

FIG. 4E illustrates the XR environment 400 during a fifth time period subsequent to the fourth time period. During the fifth time period, in response to detecting that the user was looking at the top of the third content pane 460C and, optionally, detecting a gesture with right hand 452 (e.g., a pinch gesture), the first stack including the third content pane 460C, the second content pane 460B, and the first content pane 460A is displayed in a stretched configuration rather than a collapsed configuration. In the stretched configuration, the content panes of the stack are displaced from each other in the depth direction the same (or, in various implementations, a different) amount as in the collapsed configuration, but are further displaced in a vertical direction such that additional portions (e.g., the title) of each content pane is visible. However, the content of only the frontmost content pane is visible. In various implementations, the content panes are aligned (e.g., not offset) in the horizontal direction. Although, the third content pane 460C, the second content pane 460B, and the first content pane 460A are not offset in the horizontal direction of the XR environment 400, they are offset in the horizontal direction on the page of FIG. 4E, due to parallax and three-dimensional perspective.

Thus, during the fifth time period, the third content pane 460C is displayed at the first location, the second content pane 460B is displayed at a fourth location displaced backward in the depth direction and upward in the vertical direction from the first location, and the first content pane 460A is displayed at a fifth location displaced backward in the depth direction and upward in the vertical direction from the fourth location.

In various implementations, the first stack including the third content pane 460C, the second content pane 460B, and the first content pane 460A is displayed in the collapsed configuration (e.g., as shown in FIG. 4D) in response to the user gazing away from the top of the stack, an explicit command or gesture from the user, or other condition.

During the fifth time period, the gaze direction indicator 451 indicates that the user is looking at the first title of the first content pane 460A. During the fifth time period, the right hand 452 performs a pinch gesture at the location of the first title (as illustrated in FIG. 4E) and a release gesture at a location of the third content pane 460C.

FIG. 4F illustrates the XR environment during a sixth time period subsequent to the fifth time period. During the sixth time period, in response to detecting the pinch gesture interacting with the first title and the release gesture associated with the location of the third content pane 460C, the first content pane 460A is moved to the top of the first stack.

In various implementations, detecting the pinch gesture interacting with the first title includes detecting a pinch gesture at the location of the first title (e.g., as illustrated in FIG. 4E). In various implementations, detecting the pinch gesture interacting with the first title includes detecting a pinch gesture at least a threshold distance from the first tile while the user is looking at the first title. In various implementations, detecting the pinch gesture interacting with the first title includes detecting a pinch gesture at least a threshold distance from any user interface element while the user is looking at the first title.

In various implementations, detecting the release gesture associated with the location of the third content pane 460C includes detecting a release gesture at the location of the third content pane 460C. In various implementations, detecting the release gesture associated with the location of the third content pane 460C includes detecting a release gesture while the user is looking at the third content pane 460C. In various implementations, detecting the release gesture associated with the location of the third content pane 460C includes detecting a release gesture at a relative position from the pinch gesture, wherein the relative position causes a corresponding change in location relative to the first title that falls within a location of the third content pane 460C.

Thus, during the sixth time period, the first content pane 460A is displayed at the first location, the third content pane 460C is displayed at the fourth location displaced backward in the depth direction and upward in the vertical direction from the first location, and the second content pane 460B is displayed at the fifth location displaced backward in the depth direction and upward in the vertical direction from the fourth location.

During the sixth time period, the gaze direction indicator 451 indicates that the user is looking at the third icon of the third content pane 460C. During the sixth time period, the right hand 452 and left hand 453 perform an expand gesture at the location of the first stack.

In various implementations, a user performs an expand gesture by contacting the index fingers of both hands and the thumbs of both hands to form a diamond shape and moving the hands away from each other. However, in various implementations, other gestures may correspond to an expand gesture.

FIG. 4G illustrates the XR environment during a seventh time period subsequent to the sixth time period. During the seventh time period, in response to detecting the expand gesture interacting with the first stack, the first stack including the first content pane 460A, the third content pane 460C, and the second content pane 460B, is displayed in an expanded configuration rather than a stretched configuration. In the expanded configuration, the content panes of the stack are displaced from each other in the depth direction in an amount larger than in (or, in various implementations, the same as) the collapsed configuration or the stretched configuration. In various implementations, the content panes of the stack are also displaced in the vertical direction and/or the horizontal direction. In the expanded configuration, the title of each content pane is visible and at least some of the content of each content pane is visible. In various implementations, the displacement of the content panes (e.g., in the depth direction, the horizontal direction, and/or the vertical direction) is proportional to a size of the expand gesture (e.g., a distance between the right hand 452 and left hand 453).

In various implementations, detecting the expand gesture interacting with the first stack includes detecting an expand gesture at the location of the first stack (e.g., as illustrated in FIG. 4F). In various implementations, detecting the expand gesture interacting with the first stack includes detecting an expand gesture at least a threshold distance from the first stack while the user is looking at the first stack. In various implementations, detecting the expand gesture interacting with the first stack includes detecting an expand gesture at least a threshold distance from any user interface element while the user is looking at the first stack.

Thus, during the seventh time period, the first content pane 460A is displayed at the first location; the third content pane 460C is displayed at a sixth location displaced backward in the depth direction (more so than the second location), upward in the vertical direction, and rightward in the horizontal direction from the first location; and the second content pane 460B is displayed at a seventh location displaced backward in the depth direction (more so than the third location), upward in the vertical direction, and rightward in the horizontal direction in the from the sixth location.

During the seventh time period, the gaze direction indicator 451 indicates that the user is looking at the third content of the third content pane 460C. During the seventh time period, the right hand 452 and left hand 453 are at an end location of the expand gesture.

FIG. 4H illustrates the XR environment 400 during an eighth time period subsequent to the seventh time period. During the eighth time period, the gaze direction indicator 451 indicates that the user is looking at the third content of the third content pane 460C. During the eighth time period, the right hand 452 and left hand 453 perform a collapse gesture at the location of the first stack.

In various implementations, a user performs a collapse gesture by orienting the palms of both hands parallel to each other and moving the hands together. However, in various implementations, other gestures may correspond to a collapse gesture.

FIG. 4I illustrates the XR environment 400 during a ninth time period subsequent to the eighth time period. During the ninth time period, in response to detecting the collapse gesture interacting with the first stack, the first stack including the first content pane 460A, the third content pane 460C, and the second content pane 460B, is displayed in the collapsed configuration rather than the expanded configuration.

In various implementations, detecting the collapse gesture interacting with the first stack includes detecting a collapse gesture at the location of the first stack (e.g., as illustrated in FIG. 4H). In various implementations, detecting the collapse gesture interacting with the first stack includes detecting a collapse gesture at least a threshold distance from the first stack while the user is looking at the first stack. In various implementations, detecting the collapse gesture interacting with the first stack includes detecting a collapse gesture at least a threshold distance from any user interface element while the user is looking at the first stack.

Thus, during the ninth time period, the first content pane 460A is displayed at the first location, the third content pane 460C is displayed at the second location, and the second content pane 460B is displayed at the third location.

During the ninth time period, the gaze direction indicator 451 indicates that the user is looking at the first content of the first content pane 460A. During the ninth time period, the right hand 452 and left hand 453 are at an end location of the collapse gesture.

FIG. 4J1 illustrates the XR environment 400 during a tenth time period subsequent to the ninth time period. During the tenth time period, the gaze direction indicator 451 indicates that the user is looking at the first title of the first content pane 460A. During the tenth time period, the right hand 452 performs a pinch gesture at the location of the first title of the first content pane 460A (illustrated in FIG. 4J1), moves to the right, and performs a release gesture at an eighth location outside of the first stack.

FIG. 4J2 illustrates an alternative embodiment of the XR environment 400 during the tenth time period. Whereas FIG. 4J1 illustrates the right hand 452 performing a pinch gesture at the location of the first title, FIG. 4J2 illustrates the right hand 452 performing a pinch gesture at a location at least a threshold distance from the first title. In particular, the pinch gesture is at a location at least a threshold distance from any user interface element. Further, the pinch gesture is at a location at least a threshold distance from the location at which the user is looking as indicated by the gaze direction indicator 451. Thus, during the tenth time period, the right hand performs at pinch gesture at a location at least a threshold distance from the first title (as illustrated in FIG. 4J2), moves to the right, an performs a release gesture at a relative location from the pinch gesture.

FIG. 4K illustrates the XR environment 400 during an eleventh time period subsequent to the tenth time period. During the eleventh time period, in response to detecting the pinch gesture interacting with the first title of the first content pane 460A, movement of the right hand 452 to the right, and the release gesture associated with the eighth location, the first content pane 460A is moved from the first location to the eighth location and a second stack having only first content pane 460A is created. Further, the third content pane 460C is moved forward to the first location and the second content pane 460B is moved forward to the second location.

In various implementations, detecting the pinch gesture interacting with the first title includes detecting a pinch gesture at the location of the first title (e.g., as illustrated in FIG. 4J1). In various implementations, detecting the pinch gesture interacting with the first title includes detecting a pinch gesture at least a threshold distance from the first tile while the user is looking at the first title. In various implementations, detecting the pinch gesture interacting with the first title includes detecting a pinch gesture at least a threshold distance from any user interface element while the user is looking at the first title.

In various implementations, detecting the release gesture associated with the eighth location includes detecting a release gesture at the eighth location. In various implementations, detecting the release gesture associated with the eighth location includes detecting a release gesture while the user is looking at the eighth location. In various implementations, detecting the release gesture associated with the eighth location includes detecting a release gesture at a relative position from the pinch gesture, wherein the relative position corresponds to a relative position between the location of the first title at which the user was looking when the pinch gesture occurred as indicated by the gaze direction indicator 451 in FIG. 4J2 and the eighth location.

During the eleventh time period, the gaze direction indicator 451 indicates that the user is looking at the first content of the first content pane 460A. During the eleventh time period, the right hand 452 is in a neutral position.

FIG. 4L illustrates the XR environment 400 during a twelfth time period subsequent to the eleventh time period. During the twelfth time period, the gaze direction indicator 451 indicates that the user is looking at the link to the fourth content of the first content pane 460A. During the twelfth time period, the right hand 452 performs a pinch gesture at the location of the link to the fourth content (illustrated in FIG. 4L), moves to the right, and performs a release gesture at a ninth location outside of the second stack.

FIG. 4M illustrates the XR environment 400 during a thirteenth time period subsequent to the twelfth time period. During the thirteenth time period, in response to detecting the pinch gesture interacting with the link to the fourth content, movement of the right hand 452 to the right, and the release gesture associated with the ninth location, a fourth content pane 460D is added to the XR environment 400 at the ninth location and a third stack having only the fourth content pane 460D is created.

In various implementations, detecting the pinch gesture interacting with the link to the fourth content includes detecting a pinch gesture at the location of the link to the fourth content (e.g., as illustrated in FIG. 4L). In various implementations, detecting the pinch gesture interacting with the link to the fourth content includes detecting a pinch gesture at least a threshold distance from the link to the fourth content while the user is looking at the link to the fourth content. In various implementations, detecting the pinch gesture interacting with the link to the fourth content includes detecting a pinch gesture at least a threshold distance from any user interface element while the user is looking at the link to the fourth content.

In various implementations, detecting the release gesture associated with the ninth location includes detecting a release gesture at the ninth location. In various implementations, detecting the release gesture associated with the ninth location includes detecting a release gesture while the user is looking at the ninth location. In various implementations, detecting the release gesture associated with the ninth location includes detecting a release gesture at a relative position from the pinch gesture, wherein the relative position corresponds to a relative position between the location of the link to the fourth content at which the user was looking when the pinch gesture occurred as indicated by the gaze direction indicator 451 in FIG. 4L and the ninth location.

The fourth content pane 460D includes, at the top of the fourth content pane 460D, a fourth icon and a fourth title (labeled “TITLE4”). The fourth content pane 460D further includes the fourth content including a fourth image and fourth text.

During the thirteenth time period, the gaze direction indicator 451 indicates that the user is looking at the fourth image of the fourth content pane 460D. During the thirteenth time period, the right hand 452 is in a neutral position.

FIG. 4N illustrates the XR environment 400 during a fourteenth time period subsequent to the thirteenth time period. During the fourteenth time period, the gaze direction indicator 451 indicates that the user is looking at the link to the fifth content of the third content pane 460C. During the fourteenth time period, the right hand 452 performs a pinch gesture at the location of the link to the fifth content (illustrated in FIG. 4L), moves to the right, and performs a release gesture at the ninth location.

FIG. 4O illustrates the XR environment 400 during a fifteenth time period subsequent to the fourteenth time period. During the fifteenth time period, in response to detecting the pinch gesture interacting with the link to the fifth content, movement of the right hand 452 to the right, and the release gesture associated with the ninth location, a fifth content pane 460E is added to the XR environment 400 at the ninth location and included as part of the third stack. Further, the fourth content pane 460E is displayed at a tenth location displaced backward from the ninth location. In various implementations, the fourth content pane 460D remains at the same depth (ninth location) and fifth content pane 460E is positioned in front of fourth content page 460D.

In various implementations, detecting the pinch gesture interacting with the link to the fifth content includes detecting a pinch gesture at the location of the link to the fifth content (e.g., as illustrated in FIG. 4N). In various implementations, detecting the pinch gesture interacting with the link to the fifth content includes detecting a pinch gesture at least a threshold distance from the link to the fifth content while the user is looking at the link to the fifth content. In various implementations, detecting the pinch gesture interacting with the link to the fifth content includes detecting a pinch gesture at least a threshold distance from any user interface element while the user is looking at the link to the fifth content.

In various implementations, detecting the release gesture associated with the ninth location includes detecting a release gesture at the ninth location. In various implementations, detecting the release gesture associated with the ninth location includes detecting a release gesture while the user is looking at the ninth location. In various implementations, detecting the release gesture associated with the ninth location includes detecting a release gesture at a relative position from the pinch gesture, wherein the relative position corresponds to a relative position between the location of the link to the fourth content at which the user was looking when the pinch gesture occurred as indicated by the gaze direction indicator 451 in FIG. 4N and the ninth location.

The fifth content pane 460E includes, at the top of the fifth content pane 460E, a fifth icon and a fifth title (labeled “TITLE5”). The fifth content pane 460E further includes the fifth content including fifth text. The fifth text includes a link to sixth content (labeled “LINK6”). In various implementations, the link to the sixth content is a link to a sixth webpage. In various implementations, the link to the sixth content is a link to a movie file.

During the fifteenth time period, the gaze direction indicator 451 indicates that the user is looking at the fifth text of the fifth content pane 460E. During the fifteenth time period, the right hand 452 is in a neutral position.

FIG. 4P illustrates the XR environment 400 during a sixteenth time period subsequent to the fifteenth time period. During the sixteenth time period, the gaze direction indicator 451 indicates that the user is looking at the first title of the first content pane 460A. During the sixteenth time period, the right hand 452 performs a pinch gesture at the location of the first title (illustrated in FIG. 4P), moves to the left, and performs a release gesture at the first location.

FIG. 4Q illustrates the XR environment 400 during a seventeenth time period subsequent to the sixteenth time period. During the seventeenth time period, in response to detecting the pinch gesture interacting with the first title, movement of the right hand 452 to the left, and the release gesture associated with the first location, the first content pane 460A is added to the first stack. Accordingly, the first content pane 460A is moved to the first location, the third content pane 460C is moved backward to the second location, and the second content pane 460B is moved backward to the third location. In various implementations, third content pane 460C and second content pane 460B remain at the same depth and first content pane 460A is positioned in front of third content pane 460C and second content pane 460B. In various implementations, if the last remaining content pane is removed from a stack, the stack is deleted or otherwise ceases to exist within the XR environment 400.

In various implementations, detecting the pinch gesture interacting with the first title includes detecting a pinch gesture at the location of the first title (e.g., as illustrated in FIG. 4P). In various implementations, detecting the pinch gesture interacting with the first title includes detecting a pinch gesture at least a threshold distance from the first title while the user is looking at the first title. In various implementations, detecting the pinch gesture interacting with the first title includes detecting a pinch gesture at least a threshold distance from any user interface element while the user is looking at the first title.

In various implementations, detecting the release gesture associated with the first location includes detecting a release gesture at the first location. In various implementations, detecting the release gesture associated with the first location includes detecting a release gesture while the user is looking at the first location. In various implementations, detecting the release gesture associated with the first location includes detecting a release gesture at a relative position from the pinch gesture, wherein the relative position corresponds to a relative position between the location of the first title at which the user was looking when the pinch gesture occurred as indicated by the gaze direction indicator 451 in FIG. 4P and the first location.

During the seventeenth time period, the gaze direction indicator 451 indicates that the user is looking at the first title of the first content pane 460A. During the seventeenth time period, the right hand 452 is in a neutral position.

FIG. 4R illustrates the XR environment 400 during an eighteenth time period subsequent to the seventeenth time period. During the eighteenth time period, the gaze direction indicator 451 indicates that the user is looking at the link to the sixth content of the fifth content pane 460E. During the eighteenth time period, the right hand 452 performs a pinch gesture at the location of the link to the sixth content (illustrated in FIG. 4R), moves to the left, and performs a release gesture at the eighth location.

FIG. 4S illustrates the XR environment 400 during a nineteenth time period subsequent to the eighteenth time period. During the nineteenth time period, in response to detecting the pinch gesture interacting with the link to the sixth content, movement of the right hand 452 to the left, and the release gesture associated with the eighth location, a sixth content pane 460F is added to the XR environment 400 at the eighth location and a fourth stack having only the sixth content pane 460F is created.

In various implementations, detecting the pinch gesture interacting with the link to the sixth content includes detecting a pinch gesture at the location of the link to the sixth content (e.g., as illustrated in FIG. 4R). In various implementations, detecting the pinch gesture interacting with the link to the sixth content includes detecting a pinch gesture at least a threshold distance from the link to the sixth content while the user is looking at the link to the sixth content. In various implementations, detecting the pinch gesture interacting with the link to the sixth content includes detecting a pinch gesture at least a threshold distance from any user interface element while the user is looking at the link to the sixth content.

In various implementations, detecting the release gesture associated with the eighth location includes detecting a release gesture at the eighth location. In various implementations, detecting the release gesture associated with the eighth location includes detecting a release gesture while the user is looking at the eighth location. In various implementations, detecting the release gesture associated with the eighth location includes detecting a release gesture at a relative position from the pinch gesture, wherein the relative position corresponds to a relative position between the location of the link to the sixth content at which the user was looking when the pinch gesture occurred as indicated by the gaze direction indicator 451 in FIG. 4R and the eighth location.

The sixth content pane 460F includes, at the top of the sixth content pane 460F, a sixth icon and a sixth title (labeled “TITLE6”). The sixth content pane 460F further includes the sixth content including a movie. In various implementations, when a link to content is dragged to an open location, a new content pane including that content is generated and displayed at that location. In various implementations, an orientation of the content pane is based on the content. For example, for a webpage, the content pane may be generated with a portrait orientation (e.g., taller than it is wide), whereas, for a movie file, the content pane may be generated with a landscape orientation (e.g., wider than it is tall).

During the nineteenth time period, the gaze direction indicator 451 indicates that the user is looking at the sixth content of the sixth content pane 460F. During the nineteenth time period, the right hand 452 is in a neutral position.

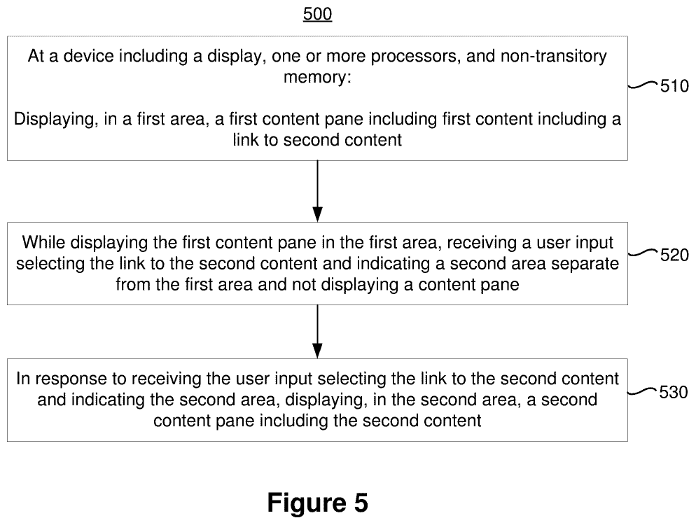

FIG. 5 is a flowchart representation of a method 500 of displaying content in accordance with some implementations. In various implementations, the method 500 is performed by a device including a display, one or more processors, and non-transitory memory (e.g., the electronic device 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device displaying, in a first area, a first content pane including first content including a link to second content. For example, in FIG. 4A, the electronic device displays, at the first location, the first content pane 460A including the first content, the first content including the link to the second content (labeled “LINK2”). As another example, in FIG. 4L, the electronic device displays, at the fourth location, the first content pane 460A including the first content including the link to the second content. In various implementations, the first content includes a webpage and the link to the second content includes a link to a second webpage, e.g., a hyperlink.

The method 500 continues, in block 520, with the device, while displaying the first content pane in the first area, receiving a user input selecting the link to the second content and indicating a second area separate from the first area and not displaying a content pane. For example, during the twelfth time period illustrated in FIG. 4L, the electronic device detects the pinch gesture interacting with the link to the second content, rightward movement of the right hand 452, and the release gesture associated with the ninth location where no content pane is displayed. As noted above, the second area is separate from the first area. Thus, in various implementations, the first area and the second area are non-overlapping. In various implementations, the first area contacts the second area. In various implementations, the first area and the second area are separated by a buffer region.

As another example, during the eighteenth time period of FIG. 4R, the electronic device detects a pinch gesture interacting with the link to the sixth content, leftward movement of the right hand 452, and the release gesture associated with the eighth location.

In various implementations, receiving the user input selecting the link to the second content includes detecting a gesture (e.g., a pinch gesture) at the location of the link to the second content. In various implementations, receiving the user input selecting the link to the second content includes detecting a gesture at least a threshold distance from the link to the second content while the user is looking at the link to the second content. In various implementations, receiving the user input selecting the link to the second content includes detecting a gesture at least a threshold distance from any user interface element while the user is looking at the link to the second content. In various implementations, receiving the user input selecting the link to the second content includes detecting a gesture at least a threshold distance from a location at which the user is looking while the user is looking at the link to the second content.

In various implementations, receiving the user input indicating a second area includes detecting the gesture (e.g., a release gesture) within the second area. In various implementations, receiving the user input indicating the second area includes detecting a gesture while the user is looking within the second area. In various implementations, receiving the user input indicating the second area includes detecting a second gesture (e.g., a release gesture) at a relative position from a gesture selecting the link to the second content, wherein the relative position causes a corresponding change in location relative to the link to the second content that falls within the second area.

Thus, in various implementations, the user input selecting the link to the second content and indicating the second area includes a first gesture performed at a location of the link to the second content and a second gesture at a location of the second area. In various implementations, the user input selecting the link to the second content and indicating the second area includes a first gesture performed at least a threshold distance from any user interface element while the user is looking at the link to the second content and a second gesture while the user is looking within the second area. In various implementations, the user input selecting the link to the second content and indicating the second area includes a first gesture performed at least a threshold distance from any user interface element while the user is looking at the link to the second content and a second gesture at a relative position from the first gesture, wherein the relative position causes a corresponding change in location relative to the link to the second content that falls within the second area. In various implementations, the first gesture is a pinch gesture and the second gesture is a release gesture.

The method 500 continues, in block 530, with the device, in response to receiving the user input selecting the link to the second content and indicating the second area, displaying, in the second area, a second content pane including the second content. Thus, in various implementations, the method 500 includes generating a new stack by a user input directed to a link and a blank location. For example, in FIG. 4M, in response to detecting a pinch-and-release gesture indicating the link to the fourth content and the ninth location, the electronic device displays the fourth content pane 460D including the fourth content at the ninth location. As another example, in FIG. 4S, in response to detecting a pinch-and-release gesture indicating the sixth content and the eighth location, the electronic device displays the sixth content pane 460F including the sixth content at the eighth location. In FIG. 4M, the fourth content pane 460D is displayed in a portrait orientation, whereas in FIG. 4S, the sixth content pane 460F is displayed in a landscape orientation. In various implementations, an orientation of the second content pane is based on the second content.

In various implementations, display of the first content pane is unchanged by the user input and the subsequent display of the second content pane. Accordingly, in various implementations, displaying, in the first area, the first content pane (at block 510) includes displaying the first content pane with first content pane dimensions and displaying, in the second area, the second content pane (at block 530) includes continuing to display the first content pane with the first content pane dimensions. Similarly, in various implementations, displaying, in the first area, the first content pane (at block 510) including displaying a first content pane at a first content pane location and displaying, in the second area, the second content pane (at block 530) includes continuing to display the first content pane at the first content pane location. For example, in FIG. 4L, the first content pane 460A is displayed with dimensions at a location and, in FIG. 4M, the first content pane 460A continues to be displayed with the same dimensions at the same location. As another example, in FIG. 4R, the fifth content pane 460E is displayed with dimensions at a location and, in FIG. 4S, the fifth content pane 460E is displayed with the same dimensions at the same location.

In various implementations, the first content or the second content includes a link to third content. In various implementations, the method 500 further includes receiving a user input selecting the link to the third content and indicating the second area and, in response to receiving the user input selecting the link to the third content and indicating the second area, displaying, in the second area, a third content pane including the third content. Thus, in various implementations, the method 500 includes adding a content pane to a stack by a user input directed to a link and a location of the stack. For example, during the fifteenth time period of FIG. 4N, the electronic device detects a pinch gesture at interacting with the link to the fifth content, rightward movement of the right hand 452, and the release gesture associated with the ninth location. In FIG. 4O, in response to the pinch-and-release gesture indicating the fifth content and the ninth location, the fifth content pane 460E is displayed at the ninth location.

In various implementations, displaying the third content pane includes displaying the second content pane in a stack with the third content pane, each content plane in the stack displaced in a depth direction. For example, in FIG. 4O, the fourth content pane 460D is displayed with the fifth content pane 460E in a stack, the fourth content pane 460D at the tenth location displayed in the depth direction (backwards) from the ninth direction.

In various implementations, the second content pane is displaced in the depth direction from a first location to a second location and the third content pane is displayed at the first location. In various implementations, the second content pane is displayed at a first location and the third content pane is displayed at a second location in front of the second content pane.

In various implementations, the method 500 includes generating a new stack by a user input directed to a content pane and a blank location. For example, during the tenth time period of FIG. 4J, the electronic device detects a pinch gesture interacting with the first content pane 460A, rightward movement of the right hand 452, and the release gesture associated with the eighth location. In FIG. 4K, in response to the pinch-and-release gesture indicating the first content pane 460A and the eighth location, the first content pane 460A is displayed at the eighth location.

In various implementations, the method 500 further includes receiving a user input selecting the first content pane and indicating the second area and, in response to receiving the user input selecting the first content pane and indicating the second area, displaying, in the second area, the first content pane in the stack. Thus, in various implementations, the method 500 includes adding a content pane to a stack by a user input directed to the content pane and a location of the stack. For example, during the sixteenth time period of FIG. 4P, the electronic device detects a pinch gesture interacting with the first content pane 460A, leftward movement of the right hand 452, and the release gesture associated with the first location. In FIG. 4Q, in response to the pinch-and-release gesture indicating the first content pane 460A and the first location, the first content pane 460A is displayed at the first location.

In various implementations, the method 500 includes receiving a stretch user input directed to the stack and, in response to receiving the stretch user input, displaying content panes of the stack in a stretched configuration. Displaying the content panes of the stack in the stretched configuration includes displacing one or more of the content panes of the stack (from a collapsed configuration) in a direction perpendicular to a depth dimension without displacing the one or more of the content panes of the stack in the depth direction. In other implementations, displaying the content panes of the stack in the stretched configuration further includes displacing the one or more of the content panes of the stack in the depth direction. In various implementations, the stretch user input includes looking at a top of the stack. For example, in FIG. 4D, the third content pane 460C, the second content pane 460B, and the first content pane 460A are displayed in a first stack in a collapsed configuration. In response to the stretch user input (e.g., looking at the top of the stack), the first stack is displayed in the stretched configuration in FIG. 4E. In particular, the second content pane 460B and first content pane 460A are displaced in a vertical direction perpendicular to the depth direction without being displayed in the depth direction.

In various implementations, the method 500 includes receiving an expand user input directed to the stack and, in response to receiving the expand user input, displaying content panes of the stack in an expanded configuration. Displaying the content panes of the stack in the expanded configuration includes displacing one or more of the content panes of the stack in a depth direction. In some implementations, displaying the content panes of the stack in the expanded configuration includes displacing the one or more of the content panes of the stack in the depth direction greater than that in the expanded configuration. In various implementations, displaying the content panes of the stack in the expanded configuration further includes displacing the one or more of the content panes of the stack in a direction perpendicular to the depth direction. For example, in FIG. 4G, the third content pane 460C, the second content pane 460B, and the first content pane 460A are displayed in the first stack in the expanded configuration. In particular, the third content pane 460C and second content pane 460D are displaced in the depth direction. Further, the third content pane 460C and second content pane 460D are displaced in the horizontal direction and the vertical direction.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, one or more processors, and non-transitory memory:
displaying, in a first area, a first content pane including first content including a link to second content;
while displaying the first content pane in the first area, receiving a user input selecting the link to the second content and indicating a second area separate from the first area and not displaying a content pane; and
in response to receiving the user input selecting the link to the second content and indicating the second area, displaying, in the second area, a second content pane including the second content.

2. The method of claim 1, wherein the first content includes a webpage and the link to the second content includes a link to a second webpage.

3. The method of claim 1 or 2, wherein the user input selecting the link to the second content and indicating the second area includes a first gesture performed at a location of the link to the second content and a second gesture at a location of the second area.

4. The method of claim 1 or 2, wherein the user input selecting the link to the second content and indicating the second area includes a first gesture performed at least a threshold distance from any user interface element while the user is looking at the link to the second content and a second gesture while the user is looking within the second area.

5. The method of claim 1 or 2, wherein the user input selecting the link to the second content and indicating the second area includes a first gesture performed at least a threshold distance from any user interface element while the user is looking at the link to the second content and a second gesture at a relative position from the first gesture, wherein the relative position causes a corresponding change in location relative to the link to the second content that falls within the second area.

6. The method of any of claims 3-5, wherein the first gesture is a pinch gesture and the second gesture is a release gesture.

7. The method of any of claims 1-6, wherein an orientation of the second content pane is based on the second content.

8. The method of any of claims 1-7, wherein the first content or the second content includes a link to third content, further comprising:
receiving a user input selecting the link to the third content and indicating the second area; and
in response to receiving the user input selecting the link to the third content and indicating the second area, displaying, in the second area, a third content pane including the third content.

9. The method of claim 8, wherein the second content pane is displaced in the depth direction from a first location to a second location and the third content pane is displayed at the first location.

10. The method of claim 8, wherein the second content pane is displayed at a first location and the third content pane is displayed at a second location in front of the second content pane.

11. The method of any of claims 8-10, further comprising:
receiving a user input selecting the third content pane and indicating a third area not displaying a content pane; and
in response to receiving the user input selecting the third content pane and indicating the third area, displaying, in the third area, the third content pane.

12. The method of any of claims 8-11, wherein displaying the third content pane includes displaying the second content pane in a stack with the third content pane, each content plane in the stack displaced in a depth direction.

13. The method of claim 12, further comprising:
receiving a user input selecting the first content pane and indicating the second area; and
in response to receiving the user input selecting the first content pane and indicating the second area, displaying, in the second area, the first content pane in the stack.

14. The method of claim 12 or 13, further comprising:
receiving a stretch user input directed to the stack; and
in response to receiving the stretch user input, displaying content panes of the stack in a stretched configuration, including displacing one or more of the content panes of the stack in a direction perpendicular to a depth dimension without displacing the one or more of the content panes of the stack in the depth direction.

15. The method of claim 14, wherein the stretch user input includes a user gazing at a top of the stack.

16. The method of any of claims 12-15, further comprising:
receiving an expand user input directed to the stack; and
in response to receiving the expand user input, displaying content panes of the stack in an expanded configuration, including displacing one or more of the content panes of the stack in a depth direction.

17. The method of claim 16, further comprising, in response to receiving the expand user input, displacing the one or more of the content panes of the stack in a direction perpendicular to the depth direction.

18. The method of any of claims 1-17, wherein displaying, in the first area, the first content pane including displaying the first content pane with first content pane dimensions and displaying, in the second area, the second content pane includes continuing to display the first content pane with the first content pane dimensions.

19. The method of any of claims 1-18, wherein displaying, in the first area, the first content pane including displaying a first content pane at a first content pane location and displaying, in the second area, the second content pane includes continuing to display the first content pane at the first content pane location.

20. A device comprising:
a display;
one or more processors;
non-transitory memory; and
one or more programs stored in the non-transitory memory, which, when executed by the one or more processors, cause the device to perform any of the methods of claims 1-19.

21. A non-transitory memory storing one or more programs, which, when executed by one or more processors of a device including a display, cause the device to perform any of the methods of claims 1-19.

22. A device comprising:
a display;
one or more processors;
a non-transitory memory; and
means for causing the device to perform any of the methods of claims 1-19.

23. A device comprising:
a display,
a non-transitory memory; and
one or more processors to:
displaying, in a first area, a first content pane including first content including a link to second content;
while displaying the first content pane in the first area, receiving a user input selecting the link to the second content and indicating a second area separate from the first area and not displaying a content pane; and
in response to receiving the user input selecting the link to the second content and indicating the second area, displaying, in the second area, a second content pane including the second content.
